(19) United States
(12) Patent Application Publication
(10) Pub. No.: US 2023/0376907 A1
(43) Pub. Date: Nov. 23, 2023

(54) SYSTEM AND METHOD FOR CREATING AND USING A NEW DATA LAYER

(71) Applicant: HIREDSCORE INC., New York, NY (US)

(72) Inventors: RACHEL ATHENA KARP, NEW YORK, NY (US); OFIR ZIV, HOLON (IL)

(21) Appl. No.: 17/750,350

(22) Filed: May 22, 2022

(51) Int. Cl. G06Q 10/10; G06K 9/62; G06F 16/28

(52) U.S. Cl. CPC G06Q 10/1053; G06K 9/6215; G06F 16/288

(57) ABSTRACT

A computerized method performed on digital data stored in a database, the method including obtaining one or more job requirements and a list of candidate resumes, extracting tasks from the resumes in the list of candidate resumes or employee profiles, converting the extracted tasks into a mathematical representation, executing a similarity function between the extracted tasks and tasks in the job requirements, assigning a score to jobs in the list of jobs according to the output of the similarity function, assigning a score to a specific candidate in the list of candidates according to the output of the similarity function.

### FIELD

The invention relates to computerized processes for creating and using a new data layer.

### BACKGROUND

Hiring the right applicants, employees, or project workers is one of the biggest challenges for every organization, from multi-national organizations to restaurant chains. Larger organizations naturally recruit more employees and workers and receive more resumes of candidates for open positions. The resumes may be received via the organizations' websites, email, or via other applications, mainly digital applications that send the resumes over the internet, for example to the organizations' Applicant Tracking System (ATS), Candidate Relationship Management System (CRM), or Vendor Management System.

Standard resumes include information about the candidate's education and professional experience. The professional experience includes professions and skills. Professions are often relatively short, 1-4 words, resembling a job title, such as “software engineer”, “product manager”, “image processing algorithms developer”, “tax attorney”, “lecturer” and the like. Skills represent the ability to do something that comes from training, experience, or practice. Skills may be technological tools used by the candidate in his/her/they previous roles, and in which the candidate gained experience and knowledge. Skills may also include support management, negotiations, Mathematics, NLP, teaching, and the like. For example, in a standard candidate's resume, the profession may be “web developer” and the skills will include “HTML”, “Azure” and “front end development”.

### SUMMARY

In one aspect of the invention a computerized method performed on digital data stored in a database is provided, the method including obtaining one or more job requirements and a list of candidate resumes, extracting tasks from the resumes in the list of candidate resumes, converting the extracted tasks into a mathematical representation, executing a similarity function between the extracted tasks and tasks in the job requirements, assigning a score to jobs in the list of jobs according to the output of the similarity function, assigning a score to a specific candidate in the list of candidates according to the output of the similarity function.

In some cases, the method further includes obtaining a graph stored in the database, the graph includes weights or other values indicating a similarity between skills and tasks, such that the weights assist the function to identify whether or not a candidate has the relevant experience for a specific task based on the skills included or inferred in the candidate's resume.

In some cases, the method further includes comparing the number of skills in a specific candidate's resume to a list of skills connected to a specific task in a graph and defining the specific candidate as having relevant experience for the specific task based on the comparison.

In some cases, the edges in the graph have weights, and the comparison includes accumulating the weights of the skills connected to the specific task and comparing the accumulated value to the threshold.

In some cases, the method further includes generating an N-dimensional vector based on the text in the tasks extracted from each resume of the candidates' resumes, such that there is a unique vector for each resume.

In some cases, the candidate may be considered as matching to a job in case the result of the similarity function is higher than a threshold. In some cases, the candidate may be considered as matching to a job in case the result of the similarity function is lower than a threshold. In some cases, the candidate may be considered as matching to a job in case the result of the similarity function is equal to a threshold.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art of how embodiments of the invention may be practiced.

In the drawings:

FIG. 1 shows a method for a software model to identify tasks in a text, according to exemplary embodiments of the invention;

FIG. 2 shows a method for a software model to identify tasks in job-related data, according to exemplary embodiments of the invention;

FIG. 3 shows a method for a software model computing a number of employees or candidates having the experience for a specific task, according to exemplary embodiments of the invention;

FIG. 4 shows a method for training a software model to identify tasks in a list of jobs, according to exemplary embodiments of the invention;

FIG. 5 shows a method for a software model to compute a match between a job requirement and one or more candidate's resumes in a list of resumes, according to exemplary embodiments of the invention.

### DETAILED DESCRIPTION

The technical challenge solved using embodiments of the invention is to match an organization's missions and business plans to information representing the organization's employees and candidates to open positions in the organization. Standard resumes include professions and skills. Professions are often relatively short and provide general information about the candidate. Skills represent technological tools known to or used by the employees/candidates. Skills alone are too limiting or specific to describe the work that needs to be done relative to the organization's needs. Organizations function according to tasks to be executed by the organization's employees or external contractors. However, tasks-based information is not commonly used as part of standard resumes, either employees or candidates. For example, the organization needs to develop a website, while the employees' resumes lack the term “website development”, which is a task, but include skills associated with website development, such as “HTML”, “Azure” and “front end development”.

There is a need to enable the organization's managers, for example, Human Resources (HR) or Talent Acquisition (TA) personnel, as well as other managers, to identify persons' resumes that match the tasks required to be performed by the organization.

The computerized solution includes algorithms and other software-based processes for using a data layer defined by business tasks. The business tasks may be extracted from candidates' resumes, job opening requirements, and the like. The business tasks enable business executives to apply software-based algorithms to perform business processes such as matching between candidates and jobs based on the tasks, and additional processes.

The term “organization” refers to a company, a school, a firm, a non-profit organization (NGO), a computerized network, infrastructure, a government-related entity having electronic equipment, and the like.

The term “business skill” or “skill” refers to the ability to do something that comes from training, experience, or practice. Skills may be technological tools used by the candidate in a previous role, professional experience or educational experience, and in which the candidate gained experience and knowledge. Skills may also include support management, negotiations, Mathematics, NLP, teaching, and the like. For example, in a standard candidate's resume, the profession may be “web developer” and the skills will include “HTML”, “Azure” and “front end development”. Other examples of skills include the following: Kafka, Linux, soc, AWS, OpenCL, Apache, selenium, yarn, windows, compiler, microservices, openly ai, PowerShell, docker, codec, assembly, Jenkins, silicon, Redis, jQuery, TensorFlow, Python, virtualization, c#, FFmpeg, SQL, MySQL, spark, c, java, ubuntu, 3d, JavaScript, database, PyTorch, OpenCV, microarchitecture, GitHub, API, compilers, html5, robotics, android, JVM, Microsoft, Hadoop, open MP, PHP, ml, Gan, azure, UI, storage, FPGA, pearl, dl, encoder, multicore, celery, Perl, git, simulation, C++, Verilog, TCP, UNIX, ethernet, ci, and emulation.

The term “business task” or “task” refers to an action or a process that serves the organization's goals. The tasks represent actions a person can do with her/his/their skills. Examples of tasks include the following: write code, build design, develop architecture, test & validation, develop an algorithm, build automation, build & deploy SaaS and PaaS, develop video technology, develop compilers, analyze performance, build infrastructure, develop security technologies, create a specification, develop simulators, build configurations, developing RF products, Develop Software for Embedded, develop a network, develop websites and the like.

The task is a representation of a higher-level skill. That is, a task is a process to be executed by one or more skills. Hence, when there is a need to match data included in different files or records, such as the organization's missions and employees' resumes, or candidates' resumes and open jobs, skills are used as raw material to extract tasks that are used to match the different files or records.

Tasks are the organization's objective, while skills are the tools used to achieve these objectives. For example, there is a need to execute 90 tasks, and these 90 tasks can be executed by 2 different skills, as each of the skills alone can be used to execute all the tasks.

The term “business profession” refers to any type of work that needs special training or a particular skill, often one that is respected because it involves a high level of education or work experience.

The term “candidate” refers to a person who may be relevant for a job, for example by receiving a data record representing job-related data of the person, such as resume, personal information and the like. The person acting as a candidate may be external to the organization. The person acting as a candidate may be an employee who is a candidate for another job in the organization.

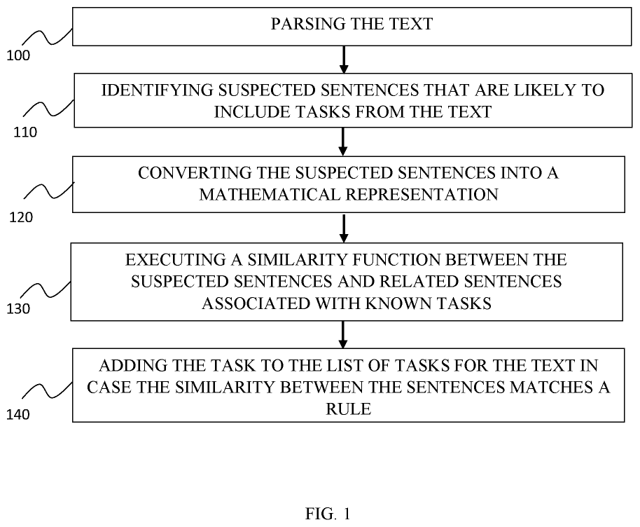

FIG. 1 shows a method for a software model to identify tasks in a text, according to exemplary embodiments of the invention. The model may be a Machine learning model.

Step 100 discloses parsing the text. Parsing may be done by a software-based application, such as parsers known by a trade name of “Sovren”, “Calamari” and others. The parsing process receives as input text, for example in a file stored in a memory address of an electronic device, text from a URL, text from a computerized application such as Applicant Tracking System (ATS), Candidate Relationship Management System (CRM), or Vendor Management System and the like. The output of the parsing process is a list of words and terms included in the text.

Step 110 discloses identifying suspected sentences that are likely to include tasks from the text. The text may be parsed, as described above. The likelihood to include tasks may be determined based on probability. The probability may be an output of a logical function that receives the suspected sentences as input and runs a set of rules to compute the probability. The probability may change over time. The suspected sentences may be identified as containing one or more terms, one or more data fields, or an order of data fields. For example, the suspected sentences may be identified as sentences that contain phrases that start with a verb or gerund-noun.

Step 120 discloses converting the suspected sentences into a mathematical representation. Conversion may be performed using a sentence embedder desired by a person skilled in the art. The mathematical representation may be a vector having N dimensions. The number of dimensions may be based on the length of each of the suspected sentences.

Step 130 discloses executing a similarity function between the suspected sentences and related sentences associated with known tasks. The similarity function receives the mathematical representations of the suspected sentences and mathematical representations of the related sentences. The related sentences are stored in a memory device accessible to the model. The related sentences comprise text defining the tasks. Examples for related sentences are provided below.

The related sentences may be extracted from the text representing the job openings. For example, creating the list of related sentences may begin with extracting sentences or phrases that start with verb/gerund noun. Then, the tasks may be tagged manually and the sentence will be mapped to the tagged task or the processor may use the clustering method (unsupervised learning model) and then go over each cluster and assign it a name. At least a portion of the sentences in the cluster will be the “related sentences” for this task.

The model first converts the related sentences into a mathematical representation, for example, a vector. Then, the model compares the vectors representing the suspected sentences with the vectors representing the related sentences, as follows: [A1, B1 . . . A1, Bn . . . An B1 . . . An, Bn], in which each of the vectors in the A group (suspected sentences) is compared with each of the vectors in the B group (related sentences).

Step 140 discloses adding the task to the list of tasks for the text in case the similarity between the sentences matches a rule. The rule may dictate that the text represents a task in case the similarity is greater than a threshold, smaller than a threshold, or any other function desired by a person skilled in the art.

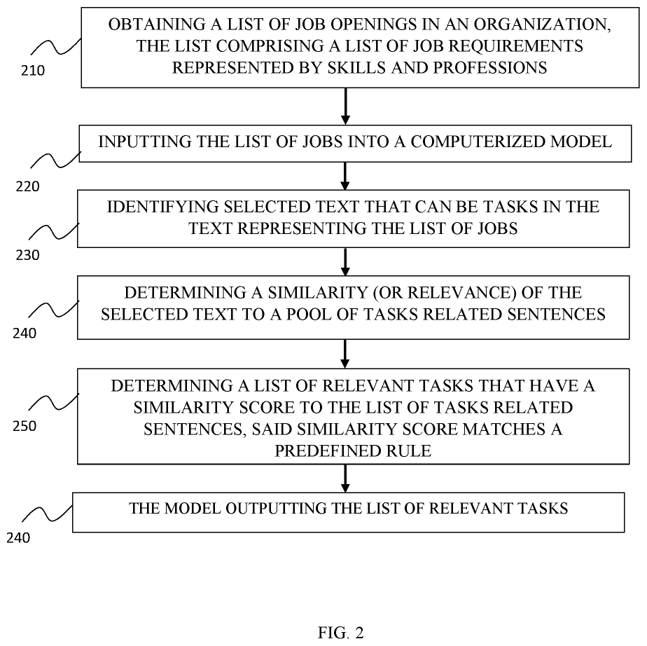

FIG. 2 shows a method for a software model to identify tasks in job-related data, according to exemplary embodiments of the invention. The model may be a Machine learning model. The job-related data may be a list of job openings with job requirements, candidates' resumes, or employee profiles, and the like.

Step 210 discloses obtaining a list of job openings in an organization, the list comprising a list of job requirements represented by skills and professions. The list of jobs is stored in a memory address of an electronic device such as a laptop, personal computer, server, and the like, or a web-based storage service such as Amazon Web Services, Google docs, and the like. The list may be stored as a file, or in another format as desired by a person skilled in the art. The list of jobs may be extracted from a server, for example via a software agent, an Application Programming Interface (API) and the like.

Step 220 discloses inputting the list of jobs into a computerized model, the model obtaining a graph of job-related tasks connected to job-related skills. Inputting may be done by electronically copying the content of the file into the model, or by downloading the content from the web-based server to the electronic device on which the model operates, such as a server, personal computer, and the like. The computerized model may be software-based. The computerized model performs a set of computerized instructions stored in digital memory, such as a random-access memory. The model may be trained to perform the processes disclosed herein.

Step 230 discloses identifying selected text that can be tasks in the text representing the list of jobs. The model may first parse the text representing the list of jobs. From the parsed content, the model may utilize a set of rules to identify tasks. The tasks may be identified as phrases beginning with verbs or ground nouns. The model may use a list of tasks stored in a memory accessible to the model. The model may compare the text in the list of jobs to items in the list of tasks.

Step 240 discloses determining a similarity (or relevance) of the selected text to a pool of tasks related sentences. The model stores or has access to a memory storing text representing a pool of tasks related sentences. The tasks-related sentences may be sentences that describe what persons are likely to describe the task in more words. For example, the task “develop algorithm” may have the following related sentences: 1. “Implement distributed algorithms”, 2. “develop new algorithms for Visual Understanding”, 3. “Implementation of imitation learning based RL algorithm”. Similarly, the task “build infrastructure” may have the following related sentences: 1. “Define and develop tools”, 2. “developing and optimizing compilers”. Also, the task “build automation” may have the following supportive sentence: 1. “provide automation for deployments”, 2. “build automation frameworks”, 3. “develop automation scripts/tools”.

The similarity may be computed by a function receiving as input at least some of the text of the tasks' related sentences and one or more of the selected text items. The function is a digital function executed by the model. The function may be a cosine function. Another option for implementing the similarity function is using Norm based similarities: L1, L2, L∞, etc. Another option for implementing the similarity function is using a machine learning model (e.g., a neural network) that learns the distance between two vectors using supervised learning on a training set.

Step 250 discloses determining a list of relevant tasks that have a similarity score to the list of tasks related sentences, said similarity score matches a predefined rule. For example, the rule may indicate that the selected text is determined as a relevant task in case the similarity score is higher or lower than a threshold.

Step 260 discloses the model outputting the list of relevant tasks. Outputting may include displaying a list of the relevant tasks on a display device, sending the list to another device, copying the list, and the like.

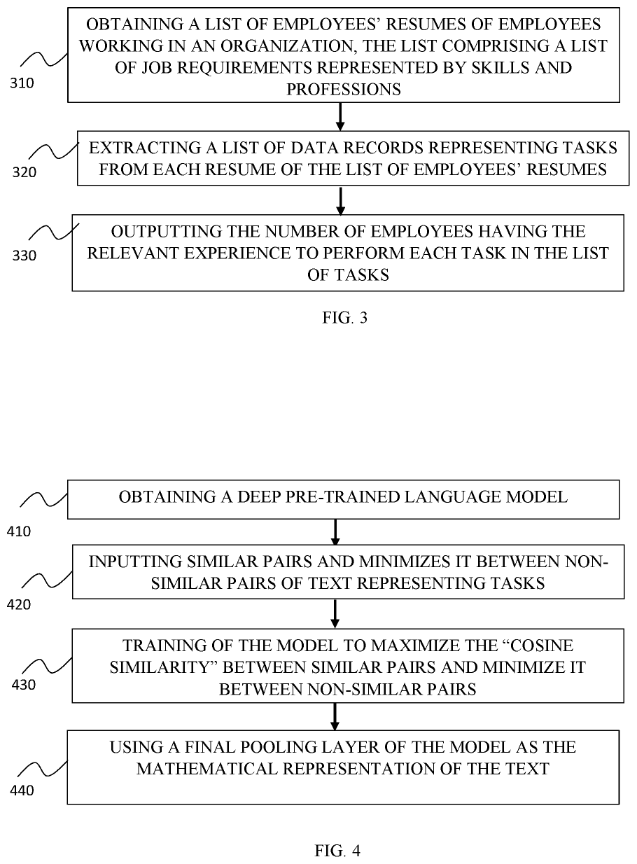

FIG. 3 shows a method for a software model computing a number of employees or candidates having the experience for a specific task, according to exemplary embodiments of the invention. The model may be a Machine learning model. The method described in FIG. 3 enables organization executives to measure the tasks their employees can provide based on the employees' resumes, hence computing the business supply that can be provided by the organization. In case the organization has a list of tasks or processes to be executed, the list of tasks can be defined as demand from the organization's personnel, and computing the number of employees capable of executing a specific task enables the organization's executives to compute the number of additional employees needed to satisfy the business demand.

Step 310 discloses obtaining a list of employees' resumes of employees working in an organization, the list comprising a list of job requirements represented by skills and professions. The list is represented by text, for example on a file or another type of digital format on a computerized memory. The employees' resumes may include more than one profession and/or more than one skill for each employee.

Step 320 discloses extracting a list of data records representing tasks from each resume of the list of employees' resumes. For example, employee #1 may have tasks #4, #21, and #55, while employee #2 may have tasks #6, #21, and #54. The tasks may be extracted from a graph connecting tasks and skills. The resumes include the skills, and the model extracts the tasks from the employees' skills. Extracting the tasks may be performed by comparing a number (e.g., 3) of skills included in the employee's resume that is connected to a task -x-, for example in a graph connecting skills and tasks. In case the number of skills is higher than a threshold, the employee may be defined as having task -x-. Extracting the tasks may be performed using a machine learning model that can predict if the employee has a task -x- by training on tagged instances in task<->skills format.

Every task can be represented by several sets of skills. The number and type of skills may vary from one task to another. The sets of skills are calculated statistically from a training set. For example, if task T associated with a set of skills {x,y,z} appears in more than N job requirements, then task T can be represented by the set {x,y,z}. If the candidate has one of the skill sets that represents a task, the candidate is considered a person that has the relevant experience to this task.

Step 330 discloses outputting the number of employees having the relevant experience to each task in the list of tasks. The relevant experience for a specific employee may be determined by computing a relevance score between an employee and a task and comparing the relevance score to a threshold. The relevance score may be computed by multiplying weights with data fields appearing in the employees' records or extracted from the employees' records. The employees' records may include the employees' resumes, a list of jobs assigned in the organization, a list of projects/processes and other matters that the employee was involved in during his/her/their time in the organization, and the like. Outputting may be performed by accumulating the tasks extracted from each of the employees' resumes. For example, task #1 may appear in 3 resumes, task #2 may appear in 31 resumes, and task #3 may appear in 20 resumes. This indicates that the organization has 3 employees having the relevant experience for task #1, 31 employees having the relevant experience for task #2, and 20 employees having the relevant experience for task #3.

FIG. 4 shows a method for training a software model to identify tasks in a list of jobs, according to an exemplary embodiment of the invention. The model may be a Machine learning model.

Step 410 discloses obtaining a deep pre-trained language model. The model may be Bidirectional Encoder Representations from Transformers (BERT) or another deep learning model in which every output element is connected to every input element, and the weightings between them are dynamically calculated based on their connection.

Step 420 discloses inputting similar pairs and minimizes it between non-similar pairs of text representing tasks. Inputting may be done by typing or copying or downloading the similar pairs represented as text or numbers into the model.

Step 430 discloses training of the model to maximize the “cosine similarity” between similar pairs and minimize it between non-similar pairs.

Step 440 discloses using a final pooling layer of the model as the mathematical representation of the text. The model used to convert the text into mathematical representation may be Bert. The model may then embed the “related sentences” and the “unseen text” and perform a similarity function. The embedding phase can be performed by Bert or another ML model.

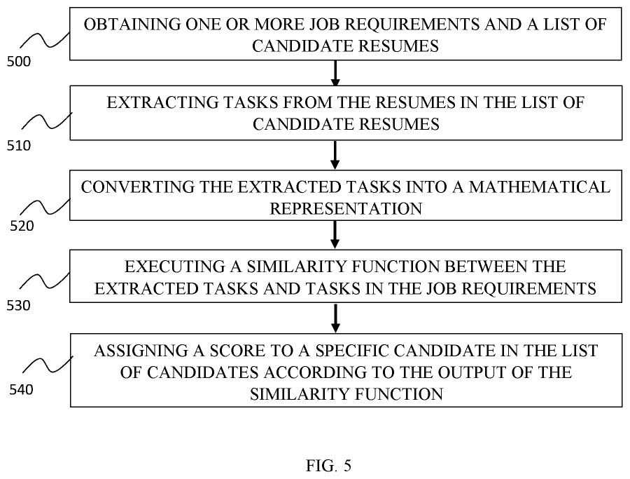

FIG. 5 shows a method for a software model to compute a match between a job requirement and one or more candidate's resumes in a list of resumes, according to exemplary embodiments of the invention.

Step 500 discloses obtaining one or more job requirements and a list of candidate resumes. The one or more job requirements and a list of candidate resumes may be stored in a database or another kind of computerized or electronic memory, for example in a memory of an electronic device, such as a laptop or a server.

Step 510 discloses extracting tasks from the resumes in the list of candidate resumes. Tasks may be extracted according to a known function that associates tasks with the information included in standard resumes, such as skills and professions. The function may use a graph stored in the database, the graph comprises weights or other values indicating a similarity between skills and tasks, such that the weights assist the function to identify whether or not a candidate has the relevant experience for a specific task based on the skills included in the candidate's resume.

Step 520 discloses converting the extracted tasks into a mathematical representation. The conversion may be done using a mathematical or logical function. The conversion may include generating an N-dimensional vector based on the text in the tasks extracted from each resume of the candidates' resumes, such that there is a unique vector for each resume.

Step 530 discloses executing a similarity function between the extracted tasks and tasks in the job requirements. The model may compare the vectors representing the tasks extracted from a specific resume with vectors representing the tasks in the job requirement.

Step 540 discloses assigning a score to a specific candidate in the list of candidates according to the output of the similarity function. The score may be represented by numbers or another string. The candidate may be considered as matching a job in case the result of the similarity function is lower than a threshold or higher than a threshold.

The processes described above are performed by a computerized system or device, for example, a server, a laptop, a tablet computer, or a personal computer. The computerized system or device comprises a processor that manages the processes. The processor may include one or more processors, microprocessors, and any other processing device. The processor is coupled to the memory of the computerized system or device for executing a set of instructions stored in the memory.

The computerized system or device comprises a memory for storing information. The memory may store a set of instructions for performing the methods disclosed herein. The memory may also store the candidates' data, the training set, the test set, rules for building the software model, and the like. The data, such as the skills layer, the tasks, job openings, resumes, and the like, may be stored in a database. The processor has access to the database when analyzing the data, such as analyzing the skills layer when extracting the tasks from the skills. The computerized system or device may also comprise a communication unit for exchanging information with other systems/devices.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiments disclosed herein as contemplated for carrying out the invention.

1. A computerized method performed on digital data stored in a database, the method comprising:
obtaining one or more job requirements for an open position and a list of candidate resumes;
extracting job-related skills from a specific candidate resume in the list of candidate resumes;
inputting the extracted job-related skills of the specific resume into a computerized model, said computerized model uses a graph comprising interconnected job-related skills and job-related tasks, wherein a task from the job-related tasks is a process to be executed by one or more job-related skills;
the model identifying a first set of job-related tasks that match the job-related skills of the specific resume based on the graph;
inputting the one or more job requirements that represent job-related skills into the computerized model, said computerized model uses the graph of interconnected job-related skills and job-related tasks;
the model identifying a second set of job-related tasks that match the one or more job requirements based on the graph;
executing a similarity function between the first set of job-related tasks and the second set of job-related tasks;
assigning a score to the specific candidate resume to fit the open position according to the output of the similarity function.

2. The method of claim 1, further comprises obtaining a graph stored in the database, the graph comprises weights or other values indicating a similarity between the job-related skills and the job-related tasks, such that the weights assist the similarity function to identify whether or not a candidate with the specific candidate resume has the relevant experience for a specific job-related task included in the open position.

3. The method of claim 1, further comprises comparing a number of job-related skills outputted by the model in the specific candidate's resume to a list of skills connected to a specific task in the graph and determining that the specific candidate matches the specific task based on the comparison.

4. The method of claim 3, wherein the graph comprises edges connecting the job-related skills and job-related tasks, the edges have weights, and the comparison comprises accumulating the weights of the skills connected to the specific task and comparing the accumulated value to a threshold.

5. The method of claim 1, further comprises generating an N-dimensional vector based on text in the job-related tasks extracted from each resume of the candidates' resumes, such that there is a unique vector for each resume.

6. The method of claim 1, wherein the candidate is considered as matching a job in case the result of the similarity function is lower than a threshold or higher than a threshold.
